(19) United States
(12) Patent Application Publication
(10) Pub. No.: US 2026/0311657 A1
(43) Pub. Date: Oct. 8, 2026

(54) LIQUID CRYSTAL DISPLAY DEVICE AND METHOD FOR DRIVING LIQUID CRYSTAL DISPLAY DEVICE

(71) Applicant: Sharp Display Technology Corporation, Kameyama City (JP)

(72) Inventor: Yuta UEYAMA, Kameyama City (JP)

(21) Appl. No.: 19/564,593

(22) Filed: Mar. 12, 2026

(30) Foreign Application Priority Data
Apr. 2, 2025 (JP) 2025-061124

(51) Int. Cl. G09G 3/36

(52) U.S. Cl. CPC G09G 3/3696; G09G 3/3677; G09G 3/3688; G09G 2310/0289; G09G 2310/065; G09G 2320/046; G09G 2330/027

(57) ABSTRACT

In a liquid crystal display device that drives a liquid crystal panel using positive and negative power supplies, a charge extraction period during which an all-on control signal is at high level is set after power-off, and a high-level voltage output to a scan line driving circuit is maintained until a middle of the period. A P-channel transistor is provided to connect a common electrode to ground. A gate terminal of the transistor is connected to ground through a resistor and is connected to an output terminal of the high-level voltage through a capacitor. A diode is connected in parallel with the resistor. The capacitor is charged using the high-level voltage through the diode before the charge extraction period. During the period, the capacitor is discharged through the resistor so that the transistor remains on from discharge start until a gate terminal voltage reaches a threshold due to the discharge.

### BACKGROUND

### 1. Field

The present disclosure relates to a liquid crystal display device and a method for driving the liquid crystal display device.

### 2. Description of the Related Art

Liquid crystal display devices are widely used due to their thin profile, light weight, and low power consumption. A liquid crystal display device includes a liquid crystal panel, a scan line driving circuit, and a data line driving circuit. In a liquid crystal panel, a plurality of pixel forming units (pixel circuits), each including thin film transistors (hereinafter referred to as TFTs), are formed in a two-dimensional array. The scan line driving circuit is also referred to as a gate driver.

In recent years, to achieve smaller device sizes, most liquid crystal display devices have employed gate driver monolithic technology, in which the scan line driving circuit is formed on the liquid crystal panel using TFTs. A scan line driving circuit formed on a liquid crystal panel is also referred to as a monolithic gate driver. A liquid crystal panel on which a scan line driving circuit is formed is also referred to as a gate driver monolithic liquid crystal panel.

Furthermore, in liquid crystal display devices, in order to reduce power consumption, a technique is sometimes adopted in which the TFTs of the liquid crystal panel are formed using an oxide semiconductor. For example, a technique for forming a TFT using indium gallium zinc oxide (hereinafter referred to as “IGZO”), the type of oxide semiconductor, has been put into practical use. The off-leakage current of a TFT formed using IGZO (hereinafter referred to as an “IGZO-TFT”) is much smaller than that of TFTs formed using other materials. Therefore, using an IGZO-TFT in a liquid crystal display device reduces the off-leakage current of the TFT and notably lowers power consumption.

In liquid crystal display devices, when the power is turned off, the discharge path of the charge held in the pixel capacitance of the pixel formation unit is cut off, leaving the charges in the liquid crystal panel. The residual charge may result in burn-in of the liquid crystal panel when the power is turned on again. Therefore, in liquid crystal display devices, a charge extraction period for removing the residual charge in the liquid crystal panel is typically provided after the power is turned off. During the charge extraction period, all scan lines of the liquid crystal panel are selected at once. During the charge extraction period, it is desirable to lower the common electrode voltage of the liquid crystal panel to ground level (0V).

In particular, in a liquid crystal display device using an IGZO-TFT, the off-leakage current of the TFT is small, and therefore the residual charge in the liquid crystal panel when the power is turned off remains for a long time without being discharged. As a result, burn-in may occur in the liquid crystal panel when the power is turned on again. Therefore, in a liquid crystal display device using an IGZO-TFT, it is desirable to adopt a configuration in which the common electrode voltage of the liquid crystal panel is rapidly lowered to ground level (0 V) during the charge extraction period, allowing the residual charge in the liquid crystal panel to be rapidly removed when the power is turned off.

As an existing technique related to the above-described technique, International Publication No. 2018/230452 discloses a liquid crystal display device including a liquid crystal panel having a common electrode and formed with an oxide semiconductor, a power supply control circuit that outputs an all-on control signal for selecting all scan lines and outputs a high-level voltage supplied to a scan line driving circuit formed in the liquid crystal panel, and a common electrode control circuit that controls the voltage of the common electrode. In this liquid crystal display device, the power supply control circuit maintains the high-level voltage supplied to the scan line driving circuit in the liquid crystal panel at a high level until the middle of the charge extraction period even after the power is turned off. In addition, the common electrode control circuit connects the common electrode to ground when the all-on control signal is at the high level and the high-level voltage is at its operating level.

In the liquid crystal display device described in International Publication No. 2018/230452, the common electrode control circuit is configured as illustrated in FIG. 6 on the assumption that the liquid crystal panel is driven using only a positive power supply, that is, the positive power supply method. In this liquid crystal display device, as illustrated in FIG. 7, the power supply control circuit 11 maintains a gate high voltage VGH2 output to a scan line driving circuit 24 formed in a liquid crystal panel 20 at a high level until the middle of the charge extraction period even after a time t0 when a power supply voltage VCC changes from 3.3V to ground level (0V) (after the power is turned off). In addition, a common electrode control circuit 30 uses two resistors 31 and 32, a NOT circuit 33, and two N-channel field effect transistors (hereinafter abbreviated as “FETs”) 34 and 35 to connect a common electrode 25 to ground when an all-on control signal ALLON is at a high level and the gate high voltage VGH2 is at an operating level. As a result, burn-in is suppressed after the power is turned on, because the voltage Vcom of the common electrode 25 falls to ground level when the power is turned off.

However, when the liquid crystal panel is formed using IGZO-TFTs, a method for driving a liquid crystal panel using both positive and negative power supplies, that is, a positive/negative power supply method may be adopted. When a positive/negative power supply method is adopted, the average voltage of the common electrode during normal driving is a negative voltage (for example, −0.3V). In the configuration illustrated in FIG. 6 described in International Publication No. 2018/230452, which employs a positive power supply method, it is difficult to operate the common electrode control circuit 30 appropriately during the charge extraction period after the power is turned off.

Therefore, in a liquid crystal display device that includes a liquid crystal panel formed with an oxide semiconductor such as IGZO and driven by both positive and negative power supplies, it is desirable to discharge the residual charge when the power is turned off so as to rapidly bring the common electrode voltage to ground level and, thus, suppress burn-in when the power is turned on again.

### SUMMARY

According to some embodiments of the present disclosure, a liquid crystal display device includes: a liquid crystal panel having a common electrode, formed with an oxide semiconductor, and driven by both positive and negative power supplies; a power supply control circuit having a control output terminal and a power output terminal and configured to output, from the control output terminal, a control signal at an active level during a period set after the power is turned off and output, from the power output terminal, a power supply voltage that is maintained at an operating level, even after the power is turned off, until at least the start of the period; and a common electrode control circuit configured to discharge a residual charge remaining on the common electrode by connecting the common electrode to ground during the period. The common electrode control circuit includes: a first capacitor; a discharge resistor connected to the first capacitor; a charge control circuit configured to charge the first capacitor using the power supply voltage so that the first capacitor has a predetermined voltage immediately before the period; a discharge control circuit configured to discharge the first capacitor through the discharge resistor when the control signal is at an active level; and a residual-charge-discharging switching element having a control terminal connected to a connection point between the first capacitor and the discharge resistor and configured to turn on during a period from when the discharge control circuit starts discharging the first capacitor until a voltage at the connection point reaches a predetermined level as a result of the discharge so that the common electrode is connected to ground.

In other embodiments of the present disclosure, a method for driving a liquid crystal display device is provided. The liquid crystal display device includes a liquid crystal panel having a common electrode, formed with an oxide semiconductor, and driven by both positive and negative power supplies. The method includes: outputting a control signal at an active level during a period set after the power is turned off; outputting a power supply voltage that is maintained at an operating level, even after the power is turned off, until at least the start of the period; and discharging a residual charge remaining on the common electrode by connecting the common electrode to ground during the period. The liquid crystal display device includes a first capacitor, a discharge resistor connected to the first capacitor, and a residual-charge-discharging switching element having a control terminal connected to a connection point between the first capacitor and the discharge resistor and configured to connect the common electrode to ground upon being turned on. The discharging a residual charge remaining on the common electrode includes: charging the first capacitor using the power supply voltage so that the first capacitor has a predetermined voltage immediately before the period; discharging the first capacitor through the discharge resistor when the control signal is at an active level; and turning on the residual-charge-discharging switching element during a period from when the first capacitor charged to the predetermined voltage starts discharging until a voltage at the connection point reaches a predetermined level as a result of the discharge.

### BRIEF DESCRIPTION OF THE DRAWINGS

FIG. 1 is a block diagram of the configuration of a liquid crystal display device according to a first embodiment;

FIG. 2 illustrates the details of a liquid crystal panel according to the first embodiment;

FIG. 3 is a signal waveform diagram illustrating the operation of the liquid crystal display device when the power is turned off, according to the first embodiment;

FIG. 4 is a block diagram illustrating the configuration of the liquid crystal display device according to a second embodiment;

FIG. 5 is a signal waveform diagram for illustrating the operation of a liquid crystal display device when the power is turned off, according to the second embodiment;

FIG. 6 is a block diagram of the configuration of an existing liquid crystal display device; and

FIG. 7 is a signal waveform diagram illustrating the operation of the existing liquid crystal display device when the power is turned off.

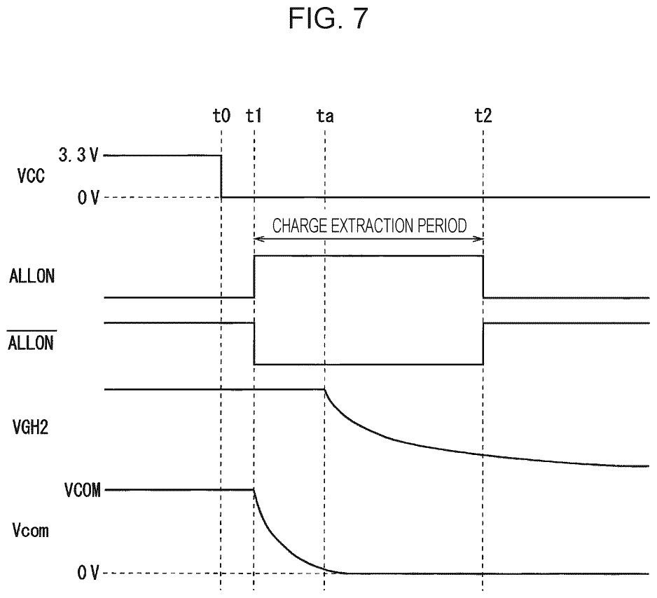

### DESCRIPTION OF THE EMBODIMENTS

Exemplary embodiments are described below with reference to the accompanying drawings. Note that in each transistor described below, a gate terminal corresponds to a control terminal, one of a drain terminal and a source terminal corresponds to a first conductive terminal, and the other corresponds to a second conductive terminal. Furthermore, for two terminal elements such as resistors and capacitors described below, one end and the other end of the element are also referred to as a “first terminal” and a “second terminal”, respectively. Furthermore, as used herein, the term “connection” means “electrical connection” unless otherwise specified, and includes a direct connection and an indirect connection via other elements, within the scope of the present disclosure.

### First Embodiment

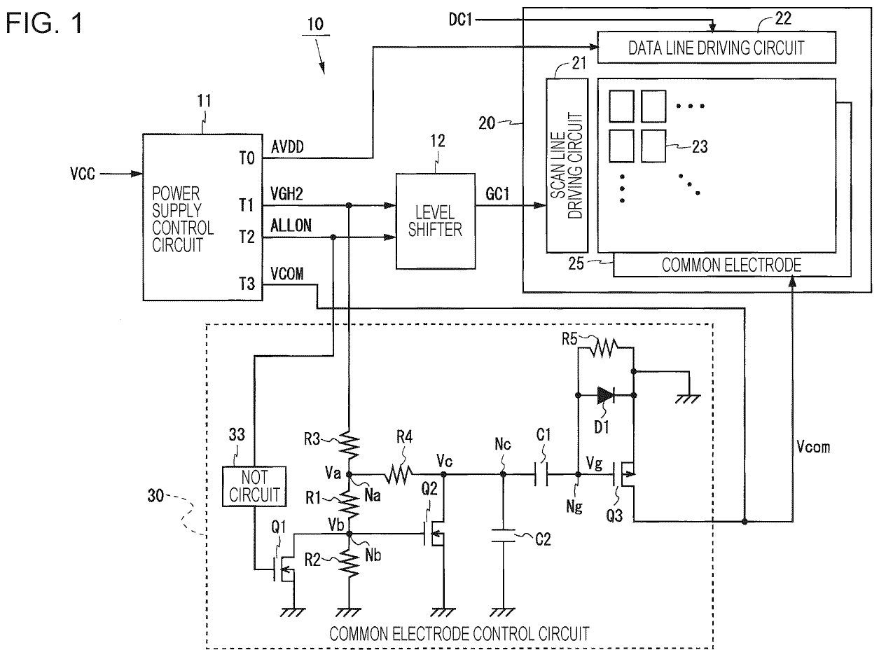

FIG. 1 is a block diagram of the configuration of a liquid crystal display device 10 according to the first embodiment. The liquid crystal display device 10 includes a power supply control circuit 11, a level shifter 12, a liquid crystal panel 20, and a common electrode control circuit 30. In typical configurations, separate IC chips are used for the power supply control circuit 11 and the level shifter 12.

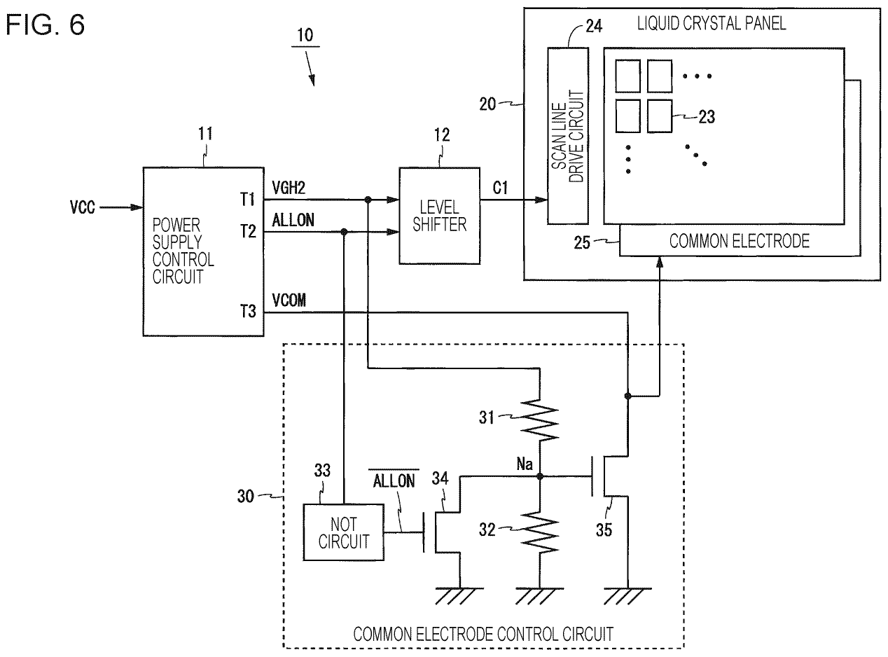

The liquid crystal display device 10 receives a power supply voltage VCC from an external power supply. Hereinafter, the power supply voltage VCC is assumed to be 3.3 V. According to the present embodiment, unlike existing liquid crystal display devices (refer to FIG. 6) that employ a positive power supply method in which a liquid crystal panel is driven using only a positive power supply, the liquid crystal display device 10 employs a positive/negative power supply method in which the liquid crystal panel 20 is driven by both positive and negative power supplies. Therefore, the average voltage of the common electrode during normal driving is a negative voltage (for example, −0.3V).

As illustrated in FIG. 1, the power supply control circuit 11 outputs various control signals and power supply voltages that enable the operation of the liquid crystal display device 10 based on the power supply voltage VCC. More specifically, the power supply control circuit 11 outputs an analog power supply voltage AVDD for driving the liquid crystal, the gate high voltage VGH2, an all-on control signal ALLON, a common electrode voltage VCOM, and the like. Hereinafter, the output terminal of the analog power supply voltage AVDD for driving the liquid crystal is referred to as “T0”, the output terminal of the gate high voltage VGH2 is referred to as “T1”, the output terminal of the all-on control signal ALLON is referred to as “T2”, and the output terminal of the common electrode voltage VCOM is referred to as “T3”.

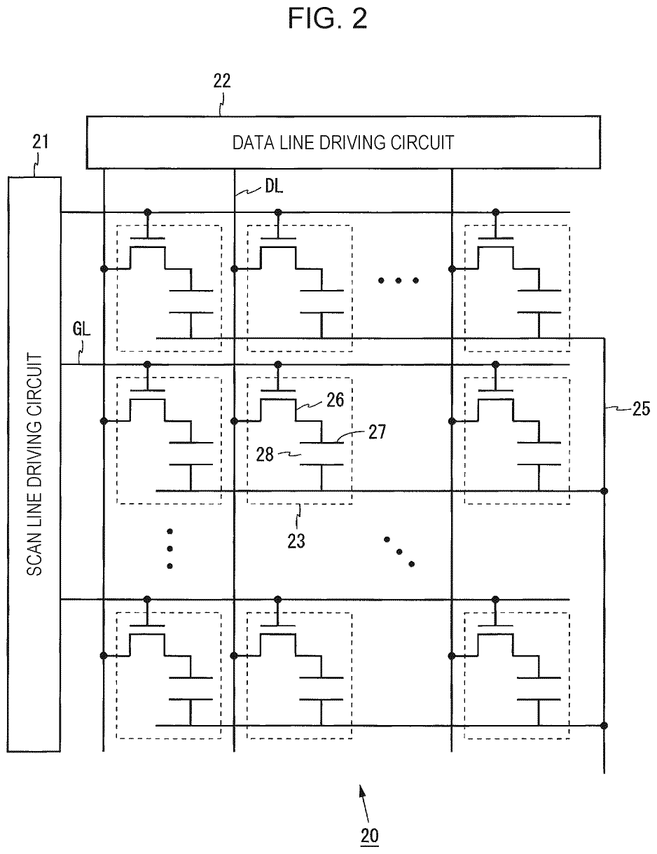

FIG. 2 illustrates the details of the liquid crystal panel 20 according to the present embodiment. As illustrated in FIG. 2, the liquid crystal panel 20 includes a plurality of scan lines GL, a plurality of data lines DL, a scan line driving circuit 21, a plurality of pixel circuits 23, and a common electrode 25. The liquid crystal panel 20 further includes an integrated circuit (IC) that functions as a data line driving circuit 22. The plurality of scan lines GL are arranged parallel to each other. The plurality of data lines DL intersect the plurality of scan lines GL and are arranged parallel to each other. The pixel circuits 23 are arranged in a two-dimensional array at the intersections of the plurality of scan lines GL and the plurality of data lines DL. The pixel circuits 23 each include TFTs 26 and pixel electrodes 27. The common electrode 25 is disposed to face all the pixel electrodes 27 included in the liquid crystal panel 20. A liquid crystal layer (not illustrated) is provided between the pixel electrode 27 and the common electrode 25 to form a liquid crystal capacitance 28 in the pixel circuit 23.

The scan line driving circuit 21 serves as a monolithic gate driver formed on the liquid crystal panel 20 using TFTs together with the pixel circuit 23. The level shifter 12 outputs a scan-side driving control signal GC1 to the scan line driving circuit 21 formed on the liquid crystal panel 20 based on the gate high voltage VGH2, the all-on control signal ALLON, a scan-side control signal from a timing controller (not illustrated), and the like. The scan line driving circuit 21 drives the scan lines GL based on the scan-side driving control signal GC1. The data line driving circuit 22 is supplied with the analog power supply voltage AVDD for driving the liquid crystal from the power supply control circuit 11, and is also supplied with a data-side driving control signal DC1 from the timing controller (not illustrated), the signal including information about an image to be displayed. The data line driving circuit 22 drives the data lines DL based on the data-side driving control signal DC1. The common electrode voltage VCOM output from the power supply control circuit 11 is applied to the common electrode 25.

The TFT 26 included in the pixel circuit 23 and a TFT (not illustrated) included in the scan line driving circuit 21 are formed using the same material and by the same manufacturing process. These TFTs are oxide TFTs having an oxide semiconductor layer formed using an oxide semiconductor. Thus, the liquid crystal panel 20 is formed with an oxide semiconductor.

The common electrode control circuit 30 includes five resistors R1 to R5 (hereinafter referred to as a first resistor R1, a second resistor R2, a third resistor R3, a fourth resistor R4, and a fifth resistor R5, respectively) and two capacitors C1 and C2 (hereinafter referred to as a first capacitor C1 and a second capacitor C2, respectively), the NOT circuit 33, two N-channel transistors Q1 and Q2 (hereinafter referred to as a first transistor Q1 and a second transistor Q2, respectively), a P-channel transistor Q3 (hereinafter referred to as a third transistor Q3), and a diode D1. The transistors Q1 to Q3 are field effect transistors. Note that the transistors Q1 to Q3 all function as switching elements.

The first to third resistors R1 to R3 are connected in series with each other. A first terminal of the first resistor R1 is connected to the terminal T1 serving as a power output terminal of the power supply control circuit 11 via the third resistor R3, and is supplied with the gate high voltage VGH2 via the third resistor R3. A second terminal of the first resistor R1 is connected to a first terminal of the second resistor R2, and a second terminal of the second resistor R2 is connected to ground. A node Na (hereinafter referred to as a “first node”) including a connection point between the first resistor R1 and the third resistor R3 is connected to a first terminal of the first capacitor C1 via the fourth resistor R4. A node Nb (hereinafter referred to as a “second node”) including a connection point between the first resistor R1 and the second resistor R2 is connected to the transistors Q1 and Q2 (described in more detail below). A node Nc (hereinafter referred to as a “third node”) including a connection point between the fourth resistor R4 and the first capacitor C1 is connected to ground via the second capacitor C2. Note that the ground potential (ground level) is 0 volts.

The NOT circuit 33 has an input terminal and an output terminal, and the input terminal is connected to the terminal T2 serving as a control output terminal of the power supply control circuit 11, and the all-on control signal ALLON is supplied to the input terminal. In response to the all-on control signal ALLON, the NOT circuit 33 outputs a negated version of ALLON (hereinafter referred to as a “signal XALLON”) from its output terminal.

The N-channel first transistor Q1 has a drain terminal connected to the second node Nb including the connection point between the second resistor R2 and the third resistor R3, a source terminal connected to ground, and a gate terminal connected to the output terminal of the NOT circuit 33 and supplied with the signal XALLON. The N-channel second transistor Q2 has a drain terminal connected to the third node Nc, a source terminal connected to ground, and a gate terminal connected to the second node Nb.

The P-channel third transistor Q3 has a drain terminal connected to the common electrode 25 of the liquid crystal panel 20 and to the terminal T3 of the power supply control circuit 11 which supplies the common electrode voltage VCOM to the drain terminal, a source terminal connected to ground, and a gate terminal connected to a second terminal of the first capacitor C1. More specifically, the drain terminal of the third transistor Q3 is connected to a wiring line that connects the terminal T3 of the power supply control circuit 11 to the common electrode 25. Furthermore, a first terminal of the fifth resistor R5 and the anode of the diode D1 are connected to a node Ng, which includes the gate terminal of the third transistor Q3 (hereinafter referred to as a “fourth node”), and a second terminal of the fifth resistor R5 and the cathode of the diode D1 are connected to ground.

In the liquid crystal display device 10, a charge extraction period is provided after the power is turned off to remove the residual charge in the liquid crystal panel 20. The gate high voltage VGH2 is a high-level voltage supplied from the power supply control circuit 11 to the scan line driving circuit 21 in the liquid crystal panel 20. The gate high voltage VGH2 is maintained at the previous high level (hereinafter referred to as an operating level) even after the power is turned off, and remains at this level until the middle of the charge extraction period.

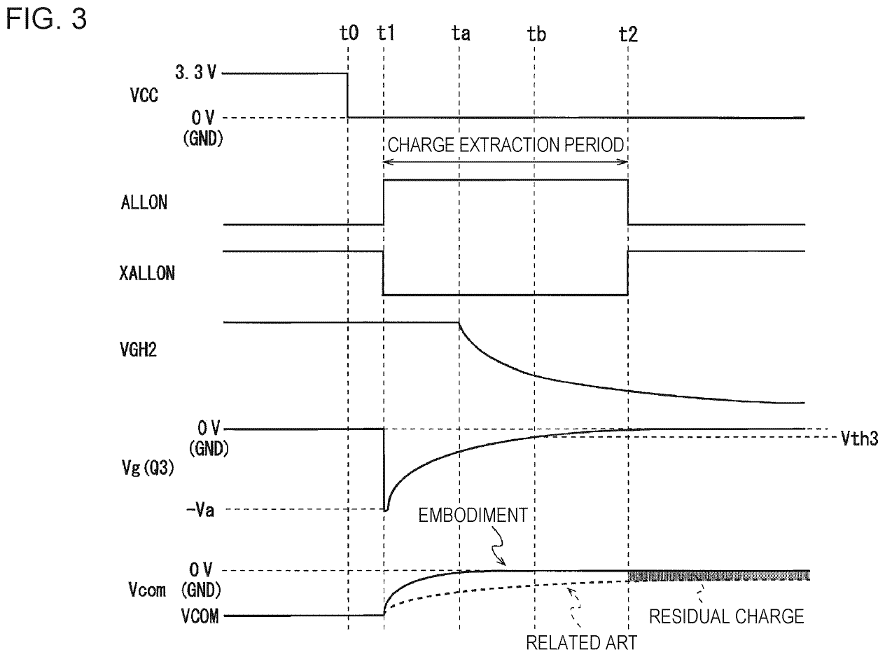

FIG. 3 is a signal waveform diagram illustrating the operation of the liquid crystal display device 10 when the power is turned off. In FIG. 3, time t0 represents the moment when the power is turned off. At time t0, the power supply voltage VCC changes from 3.3V to ground level. The charge extraction period is set from time t1 to time t2 after the power is turned off. The all-on control signal ALLON is at a high level (active level) during the charge extraction period and at a low level (inactive level) at other times. The gate high voltage VGH2 remains at the operating level (high level) until the middle of the charge extraction period, even after the power is turned off. Hereinafter, let ta denote the time when the gate high voltage VGH2 starts to decrease. Also, let “Vcom” denote the voltage of the common electrode 25 to distinguish it from the common electrode voltage VCOM output from the power supply control circuit 11. Note that an output circuit in the data line driving circuit 22 is configured so that each data line DL is grounded during the charge extraction period from t1 to t2.

Before time t1, the gate high voltage VGH2 is at the operating level (H level), the all-on control signal ALLON is at the inactive level (L level), and the signal XALLON is at the active level (H level). Therefore, the first transistor Q1 is in an on state, and a voltage Vb of the second node Nb (hereinafter referred to as a “second node voltage”) is at ground level (ground potential 0V). The second transistor Q2 is in an off state. Before time t1, a predetermined negative voltage output from the power supply control circuit 11 serves as the common electrode voltage VCOM and is applied to the common electrode 25. Accordingly, the voltage Vcom of the common electrode 25 is equal to the common electrode voltage VCOM output from the power supply control circuit 11. Furthermore, before time t1, the gate high voltage VGH2 charges the second capacitor C2 through the third resistor R3 and the fourth resistor R4, and charges the first capacitor C1 through the third resistor R3, the fourth resistor R4, and the diode D1. It is assumed that the resistance values of the third resistor R3 and the fourth resistor R4, and the capacitance values of the first capacitor C1 and the second capacitor C2 are determined so that the capacitors C1 and C2 are sufficiently charged immediately before time t1. Thus, immediately before time t1, the current flowing through the fourth resistor R4 can be regarded as 0. Accordingly, a voltage Va of the first node Na (hereinafter referred to as a “first node voltage”) is given as follows:

Va={R1/(R1+R3)}×VGH2 . . . ( 1),

where R1 to R5 also represent the resistance values of the first to fifth resistors R1 to R5, respectively.

Immediately before time t1, the first node voltage Va determined by equation (1) is held in both capacitors C1 and C2.

At time t1, the all-on control signal ALLON changes from L level to H level. Accordingly, the signal XALLON changes from H level to L level, and the first transistor Q1 turns off. As a result, a current flows through the second resistor R2, thus increasing the second node voltage Vb. Here, it is assumed that the resistance value of the second resistor R2 is set so that the second node voltage Vb given by equation (2) is higher than the threshold value Vth2 (>0) of the N-channel second transistor Q2:

Vb={R2/(R1+R2+R3)}×VGH2 . . . ( 2).

Accordingly, when the first transistor Q1 turns off, the second node voltage Vb increases and exceeds the threshold value Vth 2 (>0) of the second transistor Q2, causing the transistor Q2 to turn on.

In this manner, after time t1, the second transistor Q2 rapidly changes from the off state to the on state, and the voltage Vc of the third node Nc (hereinafter referred to as a “third node voltage”) falls to ground level (0V). As a result, the capacitors C1 and C2 start to discharge. The second capacitor C2 is rapidly discharged through the second transistor Q2 that is in an on state. However, during the discharge of the first capacitor C1, the voltage at the second terminal of the first capacitor C1 rapidly changes from ground level (0V) to a negative voltage −Va after time t1, and a discharge current then flows from ground to the first capacitor C1 through the fifth resistor R5. Therefore, after time t1, the voltage at the second terminal of the first capacitor C1, that is, a voltage Vg at the gate terminal of the third transistor Q3 (hereinafter referred to as a “gate voltage”), gradually increases from the negative voltage −Va toward ground level (0 V) with a time constant determined by the resistance value of the fifth resistor R5 and the capacitance value of the first capacitor C1.

As described above, the gate voltage Vg of the P-channel third transistor Q3 is the negative voltage −Va immediately after time t1, and the resistance values of the first to third resistors R1 to R3 are determined so that the negative voltage −Va is sufficiently lower than a threshold value Vth3 (<0) of the third transistor Q3 (refer to equation (1) described above). As a result, the third transistor Q3 turns on immediately after time t1 and remains on until time tb when the gate voltage Vg rises and reaches the threshold value Vth3. Furthermore, as described above, the output circuit in the data line driving circuit 22 is configured so that each data line DL is grounded during the charge extraction period. Therefore, during the charge extraction period set after the power is turned off (the period during which the all-on control signal ALLON is at H level), a current flows from ground to the common electrode 25, which is at a negative voltage (Vcom<0), through the on-state P-channel transistor Q3, so that the residual charge remaining on the common electrode 25 (i.e., the charge remaining in the capacitance formed between the common electrode 25 and the pixel electrode 27) is discharged (refer to FIG. 2).

As described above, the second transistor Q2 is turned on immediately after time t1 following the power being turned off and, therefore, discharge (charge extraction) of the residual charge remaining on the common electrode 25 starts. However, as illustrated in FIG. 3, at time ta after time t1, the gate high voltage VGH2 starts to decrease. Accordingly, at a time after time ta, the second transistor Q2 may no longer be able to remain in the on state, and the gate voltage Vg of the third transistor Q3 may rise together with the third node voltage Vc. However, the second transistor Q2 remains in an on state at least until time ta, during which the residual charge remaining on the common electrode 25 is discharged. Furthermore, since the third node Nc, including the first terminal of the first capacitor C1, is grounded through the second capacitor C2, the third node voltage Vc stays near ground level (0V) for a while after the second transistor Q2 is turned off at a time after time ta. This ensures time for the residual charge remaining on the common electrode 25 to be continuously discharged even after the second transistor Q2 is turned off at the time after time ta.

In a liquid crystal display device that includes a liquid crystal panel formed with an oxide semiconductor such as IGZO and employs a positive/negative power supply method, if an existing configuration using an N-channel transistor (FET) is adopted in the common electrode control circuit as illustrated in FIG. 6, the residual charge on the common electrode is not sufficiently discharged when the power is turned off, resulting in remaining charge (refer to the Vcom waveform indicated by the dotted line in FIG. 3).

In contrast, according to the present embodiment, as described above, when the first capacitor C1 is charged with the voltage Va applied to its first terminal, and the second transistor Q2 is subsequently turned on to ground the first terminal (third node Nc), the gate voltage Vg of the P-channel third transistor Q3 becomes the negative voltage −Va. As a result, the third transistor Q3 turns on for a predetermined period. Thus, in a liquid crystal display device that includes a liquid crystal panel formed with an oxide semiconductor such as IGZO and employs a positive/negative power supply method, the residual charge remaining on the common electrode 25 when the power is turned off can be discharged, the voltage Vcom of the common electrode 25 can be changed from a negative voltage to ground level (0 V) (refer to the Vcom waveform indicated by the solid line in FIG. 3), and burn-in after the power is turned on again can be suppressed.

As can be seen from the above description of the present embodiment, in the common electrode control circuit 30 illustrated in FIG. 1, the third transistor Q3 functions as a residual-charge-discharging switching element, and the fifth resistor R5 functions as a discharge resistor for the first capacitor C1. Furthermore, the third and fourth resistors R3 and R4 and the diode D1 constitute a charge control circuit that controls charging of the first capacitor C1, and the first and second transistors Q1 and Q2, the NOT circuit 33, the first and second resistors R1 and R2, and the second capacitor C2 constitute a discharge control circuit that controls discharging of the first capacitor C1.

In the above description, the power supply voltage VCC is 3.3V; however, the power supply voltage VCC may be set to 5V or higher. In this case, the burn-in suppression effect after the power is turned on is further increased. Note that the third resistor R3 has a function of adjusting the charging voltage of the first capacitor C1, the fourth resistor R4 has a function of suppressing an excessive current when charging the first capacitor C1 and the like, and the second capacitor C2 has a function of maintaining the third node voltage Vc at near ground level (0V) for a while after the second transistor Q2 is turned off due to a decrease in the gate high voltage VGH2 after time ta. However, even without the third resistor R3, the fourth resistor R4, and the second capacitor C2, the effect of discharging the residual charge remaining on the common electrode 25 when the power is turned off and bringing the voltage of the common electrode to ground level can still be obtained. Therefore, the third resistor R3, the fourth resistor R4, and the second capacitor C2 may be removed (short-circuit replacement of the third resistor R3 and the fourth resistor R4 and open-circuit replacement of the second capacitor C2 may be performed).

### Second Embodiment

According to the first embodiment, the common electrode control circuit 30 operates based on the gate high voltage VGH and the all-on control signal ALLON. However, a common electrode control circuit that operates in the same manner as the common electrode control circuit 30 can be formed by using the analog power supply voltage AVDD for driving the liquid crystal, which is a positive power supply voltage supplied to the data line driving circuit 22, instead of the gate high voltage VGH2. Hereinafter, a second embodiment describes a liquid crystal display device including such a common electrode control circuit. Note that, in the following description, configurations similar to those described in the first embodiment are identified by the same reference numerals, and detailed description thereof is omitted. The configuration and operation of the present embodiment that are not described in detail below are the same as those of the first embodiment.

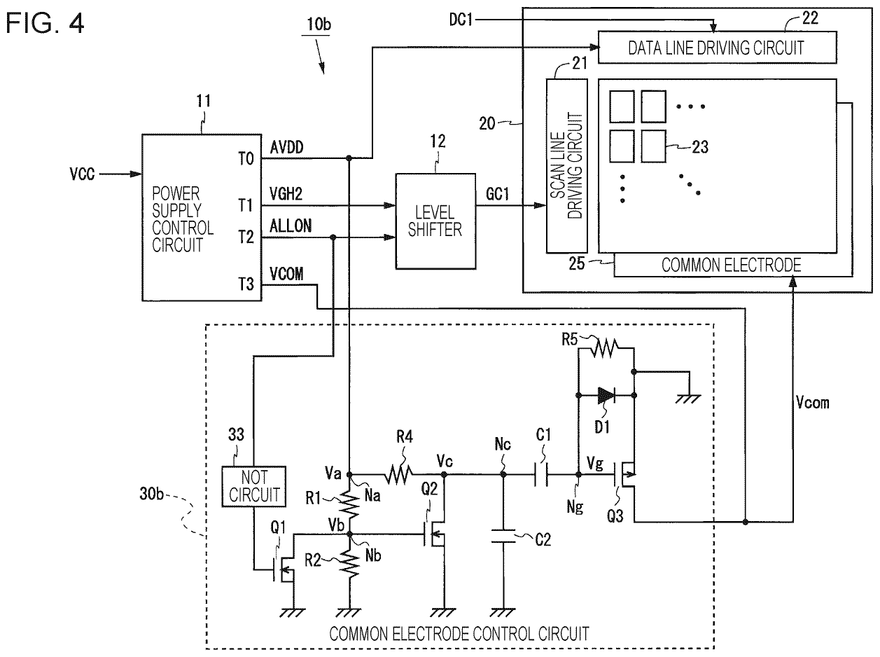

FIG. 4 is a block diagram illustrating the configuration of the liquid crystal display device 10b according to the present embodiment. In the present embodiment as well, a liquid crystal panel 20 is formed with an oxide semiconductor, and a liquid crystal panel 20 is driven by both positive and negative power supplies.

As can be seen from a comparison of FIG. 4 and FIG. 1, a common electrode control circuit 30b of the present embodiment differs from the common electrode control circuit 30 of the first embodiment in that it does not include the third resistor R3. In addition, instead of the gate high voltage VGH2, the common electrode control circuit 30b is supplied with a positive analog power supply voltage AVDD for driving the liquid crystal (hereinafter simply referred to as “analog power supply voltage AVDD”) from the power supply control circuit 11. In the common electrode control circuit 30b, the first node Na is connected to the terminal T0 serving as the power output terminal of the power supply control circuit 11 with no resistor interposed.

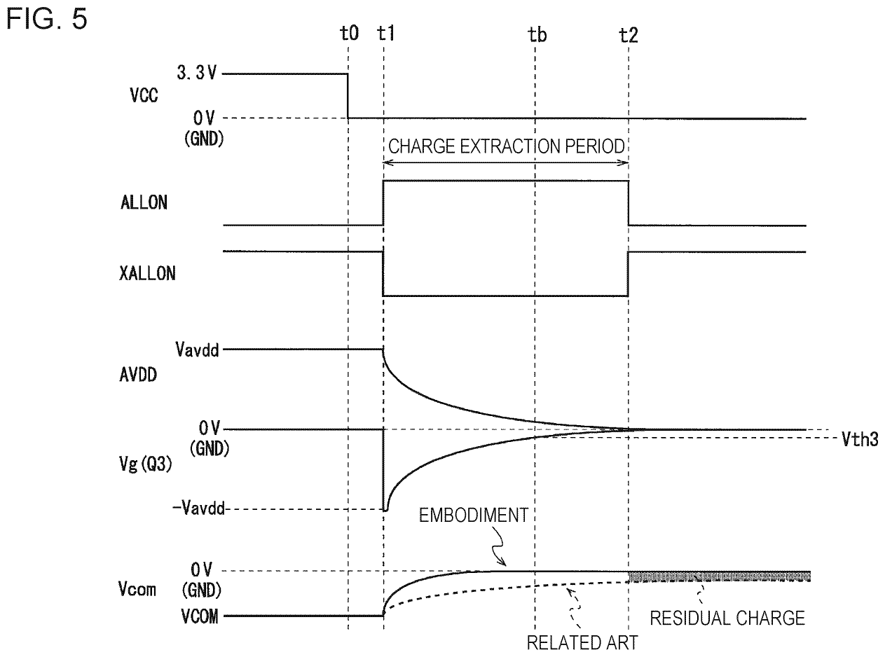

FIG. 5 is a signal waveform diagram for illustrating the operation of the liquid crystal display device according to the present embodiment when the power is turned off. As illustrated in FIG. 5, the analog power supply voltage AVDD remains at its operating level (positive voltage Vavdd) even after the power is turned off, and stays at that level until the start time t1 of the charge extraction period. However, unlike the gate high voltage VGH2, it starts to decrease after the start time t1. In addition, the operating level of the analog power supply voltage AVDD is lower than that of the gate high voltage VGH2.

As illustrated in FIG. 5, in the present embodiment as well, the power supply voltage VCC changes from 3.3V to ground level at time t0, and the charge extraction period is set from time t1 to time t2 after the power is turned off. The all-on control signal ALLON is at the H level (active level) during the charge extraction period, and at L level (inactive level) at other times. The analog power supply voltage AVDD remains at the operating level (positive voltage Vavdd) until the start time t1 of the charge extraction period, after the power is turned off. After time t1, the voltage decreases toward ground level (0 V). Since the analog power supply voltage AVDD is directly applied from the power supply control circuit 11 to the first node Na of the common electrode control circuit 30b with no resistor interposed, the first node voltage Va remains at the operating level (positive voltage Vavdd) until time t1. Furthermore, before time t1, the all-on control signal ALLON is at L level, and the signal XALLON is at the H level. Therefore, the first transistor Q1 is in an on state, the second node voltage Vb is at ground level (0 V), and the second transistor Q2 is in an off state. Accordingly, the capacitors C1 and C2 are charged by the first node voltage Va (=Vavdd) through the fourth resistor R4, and the first node voltage Va (=Vavdd) is held in both the capacitors C1 and C2 immediately before time t1. Note that before time t1, a predetermined negative voltage output from the power supply control circuit 11 is applied to the common electrode 25 as the common electrode voltage VCOM, and the voltage Vcom of the common electrode 25 is equal to the common electrode voltage VCOM output from the power supply control circuit 11.

At time t1, the all-on control signal ALLON changes from L level to H level. Accordingly, the signal XALLON changes from H level to L level, and the first transistor Q1 turns off. The second node voltage Vb during the charge extraction period is given as follows:

Vb={R2/(R1+R2)}×AVDD . . . ( 3).

The resistance values of the first and second resistors R1 and R2 are determined such that, when the second node voltage Vb indicated by equation (3) is applied to the gate terminal of the second transistor Q2, the second transistor Q2 is turned on. Therefore, at time t1, the second transistor Q2 changes from the off state to the on state, and the third node voltage Vc changes to ground level (0V). As a result, the capacitors C1 and C2 start to discharge. The second capacitor C2 is rapidly discharged through the second transistor Q2 that is in the on state. However, during the discharging of the first capacitor C1, the voltage at the second terminal of the first capacitor C1 changes from ground level (0V) to a negative voltage −Va (=−Vavdd) immediately after time t1, and a discharge current then flows from ground to the first capacitor C1 through the fifth resistor R5. Therefore, after time t1, the voltage at the second terminal of the first capacitor C1, that is, the gate voltage Vg of the third transistor Q3, gradually increases from the negative voltage −Vavdd toward ground level (0 V) with a time constant determined by the resistance value of the fifth resistor R5 and the capacitance value of the first capacitor C1.

As described above, the gate voltage Vg of the P-channel third transistor Q3 is equal to the negative voltage −Vavdd immediately after time t1, but the negative voltage −Vavdd is sufficiently lower than the threshold value Vth3 (<0) of the third transistor Q3. Therefore, as illustrated in FIG. 5, as in the first embodiment (refer to FIG. 3), the third transistor Q3 turns on immediately after time t1 and remains in the on state until time tb, when the gate voltage Vg increases to its threshold value Vth3. Therefore, during the charge extraction period set after the power is turned off (the period during which the all-on control signal ALLON is at H level), a current flows from ground to the common electrode 25 at a negative voltage (Vcom<0) through the P-channel transistor Q3 that is in the on-state. As a result, the residual charge remaining on the common electrode 25 is discharged (refer to FIG. 2).

As described above, the second transistor Q2 is turned on at time t1 after the power is turned off and, therefore, discharging (charge extraction) of the residual charge remaining on the common electrode 25 starts. However, as illustrated in FIG. 5, at time t1, the analog power supply voltage AVDD starts to decrease. Accordingly, at a time after time t1, the second transistor Q2 may no longer be able to remain in the on state, and the gate voltage Vg of the third transistor Q3 may rise together with the third node voltage Vc. However, since the third node Nc, including the first terminal of the first capacitor C1, is grounded through the second capacitor C2, the third node voltage Vc stays near ground level (0V) for a while after the second transistor Q2 is turned off at a time after time t1. This ensures time for the residual charge remaining on the common electrode 25 to be continuously discharged through the third transistor Q3.

As described above, according to the present embodiment, the first capacitor C1 is charged with the voltage Va (=Vavdd) applied to its first terminal and thereafter, the second transistor Q2 is turned on, and the first terminal (third node Nc) is grounded. As a result, the gate voltage Vg of the P-channel third transistor Q3 becomes the negative voltage −Va (=−Vavdd), and the third transistor Q3 is in an on state during a predetermined period. Consequently, in a liquid crystal display device that includes a liquid crystal panel formed with an oxide semiconductor such as IGZO and adopts a positive/negative power supply method, the residual charge remaining on the common electrode 25 can be sufficiently discharged when the power is turned off, unlike in the existing configuration in which the residual charge on the common electrode is insufficiently discharged when the power is turned off. Accordingly, the voltage Vcom of the common electrode 25 can be brought to ground level (0 V) (refer to the Vcom waveform shown as a solid line in FIG. 5). Thus, the same effects as in the first embodiment (refer to FIG. 3) can be obtained in the present embodiment as well.

The present disclosure contains subject matter related to that disclosed in Japanese Priority Patent Application JP 2025-061124 filed in the Japan Patent Office on Apr. 2, 2025, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display device comprising:
a liquid crystal panel having a common electrode, formed with an oxide semiconductor, and driven by both positive and negative power supplies;
a power supply control circuit having a control output terminal and a power output terminal and configured to output, from the control output terminal, a control signal at an active level during a period set after the power is turned off and output, from the power output terminal, a power supply voltage that is maintained at an operating level, even after the power is turned off, until at least the start of the period; and
a common electrode control circuit configured to discharge a residual charge remaining on the common electrode by connecting the common electrode to ground during the period,
wherein the common electrode control circuit includes:
a first capacitor;
a discharge resistor connected to the first capacitor;
a charge control circuit configured to charge the first capacitor using the power supply voltage so that the first capacitor has a predetermined voltage immediately before the period;
a discharge control circuit configured to discharge the first capacitor through the discharge resistor when the control signal is at an active level; and
a residual-charge-discharging switching element having a control terminal connected to a connection point between the first capacitor and the discharge resistor and configured to turn on during a period from when the discharge control circuit starts discharging the first capacitor until a voltage at the connection point reaches a predetermined level as a result of the discharge so that the common electrode is connected to ground.

2. The liquid crystal display device according to claim 1,
wherein the liquid crystal panel includes a plurality of scan lines, and
wherein the control signal is an all-on control signal for selecting all of the plurality of scan lines.

3. The liquid crystal display device according to claim 2, wherein a scan line driving circuit configured to drive the plurality of scan lines is formed inside the liquid crystal panel, and
wherein the power supply voltage is a high-level voltage output to the scan line driving circuit.

4. The liquid crystal display device according to claim 2,
wherein the power supply control circuit maintains the power supply voltage at an operating level until a middle of the period after the power is turned off,
wherein the charge control circuit includes:
a first node connected to the power output terminal and connected to a first terminal of the first capacitor; and
a diode having an anode connected to a second terminal of the first capacitor and a cathode connected to ground,
wherein the discharge control circuit includes:
a second node;
a first resistor having a first terminal connected to the first node and a second terminal connected to the second node;
a second resistor having a first terminal connected to the second node and a second terminal connected to ground;
a NOT circuit having an input terminal connected to the control output terminal and an output terminal that outputs a negated version of the control signal;
a first switching element having a first conductive terminal connected to the second node, a second conductive terminal connected to ground, and a control terminal connected to the output terminal of the NOT circuit; and
an N-channel transistor that serves as a second switching element having a first conductive terminal connected to the first terminal of the first capacitor, a second conductive terminal connected to ground, and a control terminal connected to the second node, and
wherein the residual-charge-discharging switching element is a P-channel transistor having a source terminal connected to ground, a drain terminal connected to the common electrode, and a gate terminal serving as the control terminal connected to the second terminal of the first capacitor and connected to ground through the discharge resistor.

5. The liquid crystal display device according to claim 4,
wherein the first node is connected to the power output terminal through a predetermined resistor and connected to the first terminal of the first capacitor through a predetermined resistor, and
wherein the discharge control circuit further includes a second capacitor having a first terminal connected to the first terminal of the first capacitor and a second terminal connected to ground.

6. The liquid crystal display device according to claim 2, further comprising:
a data line driving circuit,
wherein the liquid crystal panel includes a plurality of data lines driven by the data line driving circuit, and
wherein the power supply voltage is a positive power supply voltage provided to the data line driving circuit.

7. The liquid crystal display device according to claim 2,
wherein the power supply control circuit maintains the power supply voltage at an operating level until the start of the period,
wherein the charge control circuit includes:
a first node connected to the power output terminal and connected to a first terminal of the first capacitor through a predetermined resistor; and
a diode having an anode connected to a second terminal of the first capacitor and a cathode connected to ground,
wherein the discharge control circuit includes:
a second node;
a first resistor having a first terminal connected to the first node and a second terminal connected to the second node;
a second resistor having a first terminal connected to the second node and a second terminal connected to ground;
a NOT circuit having an input terminal connected to the control output terminal and an output terminal that outputs a negated version of the control signal;
a first switching element having a first conductive terminal connected to the second node, a second conductive terminal connected to ground, and a control terminal connected to the output terminal of the NOT circuit;
an N-channel transistor serving as a second switching element having a first conductive terminal connected to the first terminal of the first capacitor, a second conductive terminal connected to ground, and a control terminal connected to the second node; and
a second capacitor having a first terminal connected to the first terminal of the first capacitor and a second terminal connected to ground, and
wherein the residual-charge-discharging switching element is a P-channel transistor having a source terminal connected to ground, a drain terminal connected to the common electrode, and a gate terminal serving as the control terminal connected to the second terminal of the first capacitor and connected to ground through the discharge resistor.

8. A method for driving a liquid crystal display device, the liquid crystal display device including a liquid crystal panel having a common electrode, formed with an oxide semiconductor, and driven by both positive and negative power supplies, the method comprising:
outputting a control signal at an active level during a period set after the power is turned off;
outputting a power supply voltage that is maintained at an operating level, even after the power is turned off, until at least the start of the period; and
discharging a residual charge remaining on the common electrode by connecting the common electrode to ground during the period,
wherein the liquid crystal display device includes:
a first capacitor;
a discharge resistor connected to the first capacitor; and
a residual-charge-discharging switching element having a control terminal connected to a connection point between the first capacitor and the discharge resistor and configured to connect the common electrode to ground upon being turned on, and
wherein the discharging a residual charge remaining on the common electrode includes:
charging the first capacitor using the power supply voltage so that the first capacitor has a predetermined voltage immediately before the period;
discharging the first capacitor through the discharge resistor when the control signal is at an active level; and
turning on the residual-charge-discharging switching element during a period from when the first capacitor charged to the predetermined voltage starts discharging until a voltage at the connection point reaches a predetermined level as a result of the discharge.

9. The method according to claim 8, wherein the liquid crystal panel includes a plurality of scan lines, and
wherein the control signal is an all-on control signal for selecting all of the plurality of scan lines.

10. The method according to claim 8, wherein in the discharging a residual charge, of the first and second terminals of the first capacitor, the terminal that is not connected to the connection point is grounded so as to discharge the residual charge.
